(19) United States
(12) Patent Application Publication
(10) Pub. No.: US 2020/0346051 A1
(43) Pub. Date: Nov. 5, 2020

(54) MECHANISM OF BREATHING APPARATUS USER IDENTIFICATION

(71) Applicant: Christian Boulan, Carlsbad, CA (US)

(72) Inventor: Christian Boulan, Carlsbad, CA (US)

(21) Appl. No.: 16/642,955

(22) PCT Filed: Sep. 4, 2018
(86) PCT No.: PCT/US2018/049363

§ 371 Date: Feb. 28, 2020

Related U.S. Application Data
(60) Provisional application No. 62/712,760, filed on Jul. 31, 2018.
(60) Provisional application No. 62/554,954, filed on Sep. 6, 2017.

(51) Int. Cl. A62B 9/00; G09F 21/02; G09F 23/00; G09F 3/00

(52) U.S. Cl. CPC A62B 9/006; G09F 3/00; G09F 23/00; G09F 21/026

(57) ABSTRACT

A mechanism with unique identification features, such as color and alphanumeric markings, for back mounted self contained breathing apparatus (SCBA), which couples and uncouples from SCBA air cylinders in a linear fashion and covers at least one end of the cylinder with a rigid body for identification of firefighters while in donned protective gear.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a mechanism of breathing apparatus user identification. More specifically, the present invention relates to a mechanism with unique identification features, such as color and alphanumeric markings, for back mounted self contained breathing apparatus (SCBA), which couples and uncouples from SCBA air cylinders in a linear fashion and covers at least one end of the cylinder with a rigid body for identification of firefighters while in donned protective gear.

### BACKGROUND OF THE INVENTION

Keeping people safe in high hazard conditions, such as fire fighting, is extremely difficult. The numerous layers of protective clothing and or gear required to function in these types of work areas makes identifying and tracking workers, such as firefighters engaged in fire suppression or rescue, a significant problem. Items like firefighter turnouts, helmets, and self contained breathing apparatus or units (SCBA), which include full face breathing masks, make identifying personnel problematic, especially in smokey and dark environments. Workers are continually harmed and killed due to the inability of others, namely crew supervisors, to accurately and rapidly account for them when it matters most. Augmenting worker equipment with identifiable markers dramatically improves the capacity of others to identify them and improves overall worker safety.

A firefighter's protective clothing covers their entire body and a self contained breathing apparatus or unit (SCBA) covers the firefighter's face. The SCBA is comprised of several components. A compressed gas cylinder (bottle) provides breathable air for the user and is worn on the back. A harness connects the bottle with the user. Air from the bottle is delivered to the user through some form of transport, like a hose. The user breathes the air from the bottle with a mechanism attached to the hose, such as a mask, that may completely cover the user's face in some manner. As air is delivered to the user from the compressed air bottle, air content is diminished and the bottle must be replaced for continued use of the system. In working conditions, the firefighter's air in the bottle may last from fifteen to forty-five minutes, depending on the size of the bottle. When the air is empty, the bottle is removed from the breathing harness and replaced with a new bottle. Many fire incidents are completed with the use of a single air bottle, but some incidents require bottle replacement.

Firefighting is dangerous work. The industry's unique protective equipment is intended to ensure workers can perform duties safely. At no point is this more essential than when firefighters are engaged in fire suppression and rescue duties. Firefighters engaged in rescue and fire suppression face risk of injury or death from high heat or smoke in an environment that offers little, if any, visibility. In this environment, workers can easily become disoriented and lost, ultimately losing their lives while working in this danger zone. Improvement in industry standards have underscored the importance of organizations putting in place strict procedures that emphasize personnel accountability. Components of a fire department personnel accountability system include the ability to know the location of all working personnel on an emergency incident and being able to quickly account for the location and status of those individuals when an unexpected event happens, such as a flashover or backdraft. A commitment to a personnel accountability system requires an improved understanding of worker locations. In no area is this more challenged and more important than interior structure fire fighting. The most basic and essential level of personnel accountability requires that everyone, especially mobile officers managing interior firefighting crews, maintain accurate location and status of assigned personnel.

Fire suppression and rescue activities are complex activities that often include the involvement of dozens of firefighters. Safe and effective management of such incidents is accomplished by fire departments through the division of incident scene priorities and the assignment of group responsibilities. Subdivided groups may involve additional groups further subdivided to complete objectives assigned to the overhead group. The base levels of groups are often comprised of several fire companies. To ensure operational efficiency and personnel safety, these fire companies are typically comprised of 2-5 personnel (i.e. an engine unit may be one captain, one engineer, and two firefighters). Working within the subdivided groups, numerous units work within the same hazard zones. Tracking the numerous personnel in these hazard zones is incredibly important and is documented in both firefighter fatality reports and industry regulations.

The National Fire Protection Association (NFPA) and the National Institute for Occupational Safety and Health (NIOSH) both emphasize the importance of firefighter accountability and tracking of workers in the dangerous conditions that firefighters work. Recommendations to improve firefighter safety by improving personnel accountability are regular ingredients found in NIOSH firefighter fatality reports. The National Fire Protection Association (NFPA) further supports the need for crew cohesion in their industry standards. NFPA 1500, Standard on Fire Department Occupational Safety, and NFPA 1561, Standard on Emergency Services Incident Management System and Command Safety, both work to improve firefighter safety by outlining operations standards that ensure supervisors can easily maintain accountability, location and status of assigned resources (firefighters).

Fire service protective equipment is subject to rigorous testing. The National Fire Protection Association (NFPA) and OSHA both work to ensure workers remain safe by establishing performance minimums. It is essential that any item added to self contained breathing apparatus (SCBA) not degrade its performance or safety of its design. Identification of workers in donned gear is a dire need, which drives organizations to select solutions that may not be as robust as industry standards demand. As such, there are items on the market that may not meet these basic performance minimums, thereby exposing firefighters to risk from accessory failure. Fabric bottle covers with stitched lettering are a current method of identification. In addition to not meeting the full needs of the industry, they may also create a safety hazard. They do not provide a mechanism for departments to easily make needed marking changes (which may arise outside of an incident when unit numbers for the agency are changed or when markings fade or are damaged) that can be accomplished through the application of sticker type markings commonly used in the industry on fire helmets.

The need for a surface that readily accepts stickers can be seen in the popularity of sticker identification on the firm surface of the fire helmet. An ideal identification method would continue to provide this benefit. The fabric material may also be a hazard. Fabric covers not designed to be form fitting may be loose and become caught on hazards in the work zone—entangling the firefighter in the hazard zone. A loose fabric bag could also easily be damaged in SCBA mounting brackets and then further create a hazard while in use in the hazard zone. Any identification method attached to the SCBA must be form fitting, durable and pass industry heat and flame tests to ensure the safety of those wearing it.

There are other methods currently in use to assist in tracking personnel in circumstances where equipment makes it difficult. Name tags, stickers or magnets on items such as work jackets, bottle covers and helmets are examples of current market options. These market options do not adequately meet the needs of the industry. User names on equipment do not meet the need of flexibility because workers names (i.e. Smith) are not easily related with unit assignments (i.e. unit 213). This is compounded in situations where individuals also rotate through positions (i.e. 219 one day/shift, then 213 the next day/shift).

The fire scene overwhelmingly requires unit identifiers, not names, be used to track personnel. Permanent unit markings on clothing, gear or SCBA bottles is impractical. Worker's unit assignments change and SCBA air bottles are frequently exchanged between various work units (i.e. 213, 415, 211). Identifying magnets (i.e. 213) on helmet sides are also problematic.

The magnets are easily damaged in high heat conditions, become easily dislodged and are often inaccurate when not updated by personnel.

The National Institute for Safety and Health (NIOSH) is the federal agency responsible for making recommendations to prevent workplace injuries and deaths. As part of this role, NIOSH completes thorough investigations of firefighter fatalities, determines contributing factors and makes recommendations to improve workplace safety. Numerous NIOSH after action firefighter fatality reports highlight contributing factors such as poor crew integrity and ineffective personnel accountability systems. The NIOSH reports also continually make recommendations to improve areas related to rapid and dependable worker identification—specifically calling firefighter location paramount and one of the most important responsibilities of incident supervisors.

A 2016 NIOSH report of a New York fire that resulted in the death of a firefighter emphasizes that “crew integrity saves lives”, a long standing safety position of the International

Association of Fire Chiefs. In this unfortunate incident, a firefighter died while battling an early morning blaze in a single family residence. The report indicates that the firefighter entered with his assigned crew into the smoke filled residence to search the residence for victims and fire extension. The company officer managing the crew worked to complete these tasks supervising several firefighters. It was not until an unknown firefighter was found by another crew face down in the basement, that the firefighter assigned to the previous company was noticed as missing from his work group. The report indicates that the supervising officer of the firefighter assumed that the firefighter was still with the crew since there were other firefighters still in the group. This unfortunate assumption is not uncommon for crews working in structure fires since donned protective firefighting equipment and interior firefighting conditions make it incredibly difficult to properly assess the identification of crew members.

The need to improve firefighter identification is repeatedly documented in fatality reports. Failure of the market to provide flexible identification methods that are accurate, easily applied and rapidly read by other workers in the danger zone continues to create significant risk for working firefighters. Improvements in the area of danger zone identification for workers wearing self contained breathing units will significantly improve worker accountability and overall worker safety.

### Definitions

The NFPA 1981, Standard on Self Contained Breathing Apparatus (SCBA) establishes levels of respiratory protection and functional requirements for SCBA and SCBA accessories. It can be seen by review of components of this standard, including those listed below, that industry regulatory agencies strive for products that meet the utmost safety standards.

NFPA 1981 accessory design requirements of the current (2013) is hereby incorporated by reference in their entirety, such requirements include:

6.7.2 All accessories attached to or integrated with SCBA shall be certified by NIOSH in accordance with 42 CFR 84 for use with that specific SCBA. The entirety of 42 CFR 84 is incorporated by reference.

6.7.3 Any accessories attached to the SCBA shall not interfere with the function of the SCBA or with the function of any of the SCBA's component parts.

6.7.4 Where SCBA are provided with an accessory or accessories that are attached to or integrated with the SCBA, the SCBA, with accessories installed, shall meet all of the design and performance requirements of this standard.

6.7.5 In all cases, such accessories shall not degrade the performance of the SCBA. NFPA 1981 accessory performance requirements of the current (2013) standard is hereby incorporated by reference, such requirements include:

7.11.2 SCBA and SCBA accessories shall be tested for heat and flame resistance as specified in section 8.11, Heat and Flame Test, and no components of the SCBA and no accessories shall have an afterflame of more than 2.2 seconds.

NFPA 1981 further includes testing parameters and details, including:

8.11.5.9 After the test oven door is closed and the oven temperature recovers to 203*F, the test exposure time of 15 minutes shall begin.

8.11.5.12 The SCBA shall then be exposed to direct flame contact for 10 seconds, +0.25 second/−0.0 seconds.

8.29.5.9. After the test oven door is closed and the oven temperature recovers to 500*F +−10*F, the test exposure time of 5 minutes, +2.0 seconds/−0.0 seconds shall begin. Recovery time shall be less than 60 seconds.

8.29.5.11 The SCBA shall then be exposed to direct flame contact for 10 seconds, +0.25 second/−0.0 seconds.

### SUMMARY OF THE INVENTION

The field of the current invention relates to a method of identifying personnel when wearing self contained breathing apparatus or units (SCBA). Devices like these are normally worn with other protective garments, which means many identifiable features, such as the face and body, are not visible and identification of users is difficult. An embodiment of the invention allows identification of users of self contained breathing apparatus or units (SCBA) to be easily identified with a removable identification mechanism placed over the back mounted SCBA compressed gas bottle (cylinder). This embodiment ensures the information is accurate and allows the information to be easily transferable to SCBA replacement bottles during extended or new work cycles.

SCBA bottles do not currently have identifiable user information that meets industry heat and flame testing standards, that won't create potential entanglement hazards, that can be easily updated with new insignia and can be readily changed between bottles. This is necessary as workers operate in dangerous fire and heat conditions that often have entanglement hazards, unit numbers change on occasion due to department reorganizations, and air cylinders are regularly changed between work units and users. Organizations use many air cylinders and permanent unit markings on air cylinders are not practical because of the transitory nature of the air cylinders themselves.

One embodiment of the invention solves this issue through the coupling of a mechanism for identifying the air cylinders user. This mechanism is slid over the cylinder end linear to the long axis of the cylinder until it sits flush against the outer cylinder surface. The shape of this embodiment is similar to the shell of the compressed air cylinder, with a diameter only slightly larger than the outer diameter of the air cylinder to ensure a form fit. A flush, form fit is essential to ensure no snag hazards are created for the user who may work in areas that such a hazard could cause entanglement and fatal entrapment. The thickness of the embodiment of the invention would be in keeping with a low profile fit and not so great as to inhibit placement of the bottle within the harness of the SCBA. As a snug fit creates vacuum and pressure between two objects in motion, one embodiment of the invention provides an air exchange hole to allow air exchange in the areas between the air cylinder and the invention when coupling and uncoupling.

Visibility is limited in the harsh environment of firefighting. It is extremely difficult for supervisors (i.e. captain, company officer) or fellow firefighters to identify individuals wearing full protective garments and SCBA. The embodiment of the current invention is located on the

SCBA compressed air cylinder of the user and is easily seen with visually identifiable information on the outer surface of the invention that includes but is not limited to: (1) color of apparatus; (2) or alpha, numeric or other identifying data on the apparatus.

An example of the benefit of one embodiment can be illustrated when fire personnel are working in a hazardous environment that requires full protective clothing, including donning of the self contained breathing unit. A supervisor (i.e. captain, company officer) responsible for the oversight of a group of personnel can easily see this embodiment of the invention placed on the air cylinder of the SCBA. The unique information found on the embodiment of the invention would inform the supervisor of which unit the worker was assigned and the embodiment of the invention that uses colors could also provide information on their work position (i.e. engineer, paramedic, firefighter).

Numerous industry documents, including minimum operational standards and post fatality report recommendations, underscore the importance of dependable worker identification and accountability. Examples of how users may be identified and grouped by unit are not limited to the following visible markings on an embodiment of the invention: 213 on red surface (captain), 213 on orange surface (lieutenant or engineer), 213 on black surface (firefighter), 213A on black surface (firefighter), 213 on blue surface (paramedic). This embodiment would allow rapid and accurate identification of all firefighters (the term firefighters is a generic industry term that applies to all personnel including but not limited to engineer, lieutenant, firefighter, paramedic, etc) assigned to the 213 captain.

It is essential that workers within high risk environments are readily identified by peers and accounted for by supervising personnel according to their work units. Crews working in the same group take equipment, such as self contained breathing units (SCBA), from the same location (SCBA stored together on respective fire apparatus). This allows SCBA to be uniquely marked as grouped together (211 red, 211 black, 211 orange) and provides a significant improvement to safety. Highly visual, an embodiment of the invention allows a supervisor to accurately note the location and identification of several workers in proximity. As bottles are often required to be changed during or between work assignments, an embodiment of the invention would allow this information to be easily transferred when exchanging air cylinders, significantly improving worker safety.

Any apparatus attached to an SCBA would be exposed to the harsh conditions found in fire suppression and rescue. As such, it is essential that it be capable of approval by appropriate regulatory bodies that establish standards to prevent firefighter injuries. The NFPA (National Fire Protection Association) and NIOSH (National Institute for Occupational Safety and Health) are two such agencies that establish standards to keep firefighters safe. NFPA's rugged standards include tests such as continued exposure temperatures of up to 500 *F and direct flame contact. The harsh work environments of firefighters requires accessories that are able to meet these regulatory agency safety benchmarks.

The apparatus can be made from a variety of items, including plastic compounds or metals suited for the appropriate environment (i.e. heat and or water) and to ensure the apparatus meets NFPA and NIOSH SCBA accessory standards.

### BRIEF DESCRIPTION OF THE DRAWINGS

The accompanying drawings are used to illustrate the theoretical principals behind the invention and to schematically illustrate various exemplary embodiments of the invention that form part of the specifications. These drawings along with the background given above and detailed description given below provide detailed explanation of the invention, and wherein:

FIG. 1 shows one example of a user, a firefighter, dressed in protective garments and a self contained breathing unit. The compressed gas cylinder of the self contained breathing apparatus is coupled with one embodiment of the invention.

FIG. 2 shows a perspective view of one embodiment of the invention and a method of placing it on a breathing cylinder linear to long axis of the cylinder.

FIG. 3 shows a top view of one embodiment of the invention with a hole placed in the top to allow air exchange when coupling and uncoupling.

FIG. 4 shows a side view of one embodiment of the invention with examples of identifying features, such as colored material and numbering.

FIG. 5 shows a view of one embodiment of the invention in use, grouping and identifying users with unique features.

### DETAILED DESCRIPTION OF THE INVENTION

Various figures and images are used to schematically illustrate the principal behind the current invention and schematically illustrate various embodiments of the current invention. Hence, the description of the various embodiments of present invention is intended to be read in connection with the accompanying drawings. These drawings and images are to be considered part of the entire written description.

The descriptions contain many specifics for the purposes of illustration and ease of explanation. However, a person of ordinary skill in the art would appreciate the many variations and alterations to the provided details are within the scope of invention. The following detailed description are not intended to limit the embodiments of the subject matter of the application or uses of such embodiments. As used herein, the word “exemplary” means “serving as an example”. Any embodiment that is described as exemplary is not necessarily to be construed as preferred or advantageous over other variations and embodiments.

In the following description, numerous specific details are set forth, such as specific dimensions and angles, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present invention. The feature or features of one embodiment can be applied to other embodiments, even though not described or illustrated, unless expressly prohibited by this disclosure or the nature of the embodiments.

The field of the current invention relates to a method of identifying personnel when wearing self contained breathing apparatus or units (SCBA). Devices like these are normally worn with other protective garments, which means many identifiable features, such as the face and body, are not visible and identification of users is difficult.

An embodiment of the invention allows identification of users of self contained breathing apparatus or units (SCBA) to be easily identified with a removable identification mechanism placed over the back mounted SCBA compressed gas bottle (cylinder). This embodiment ensures the information is accurate and allows the information to be easily transferable to SCBA replacement bottles during extended or new work cycles.

SCBA bottles do not currently have identifiable user information that meets industry heat and flame testing standards, that won't create potential entanglement hazards, that can be easily updated with new insignia and can be readily changed between bottles. This is necessary as workers operate in dangerous fire and heat conditions that often have entanglement hazards, unit numbers change on occasion due to department reorganizations, and air cylinders are regularly changed between work units and users. Organizations use many air cylinders and permanent unit markings on air cylinders are not practical because of the transitory nature of the air cylinders themselves.

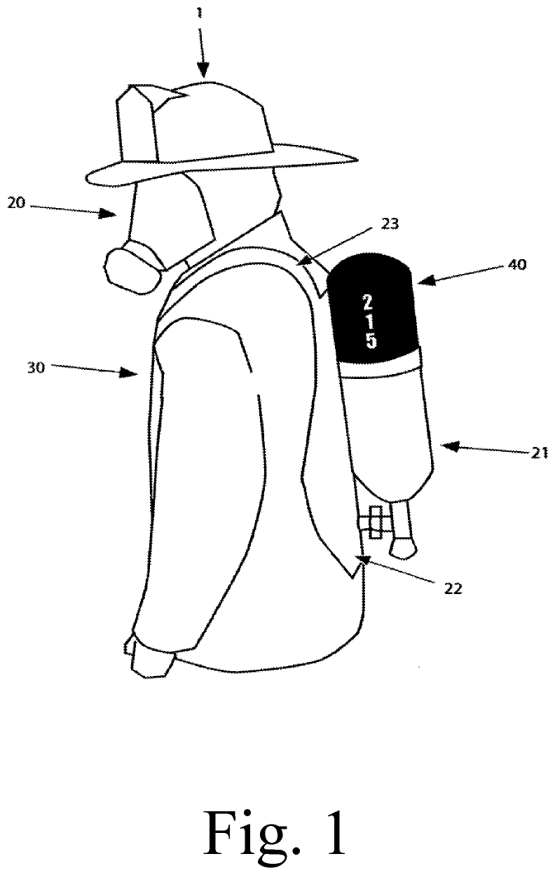

FIG. 1 shows one embodiment of the invention with one example of a user, a firefighter 1, using a self contained breathing apparatus or unit (SCBA) 22. The firefighter 1 is dressed in protective garments 30, and is wearing one self contained breathing unit 22, which includes the air cylinder 21, mechanism to hold the bottle to the user, the harness 23, and a face covering mask 20. The combination of these items makes identification of the user 1 difficult. The embodiment of the current invention 40 covers the compressed air cylinder 21, with a flush fit and is transferable between cylinders 21. Work cycles for personnel often require them to exchange air cylinders 21. When the user, firefighter 1, changes air cylinders 21 during their work cycle, the embodiment of the current invention 40 is removed and placed on the new cylinder 21.

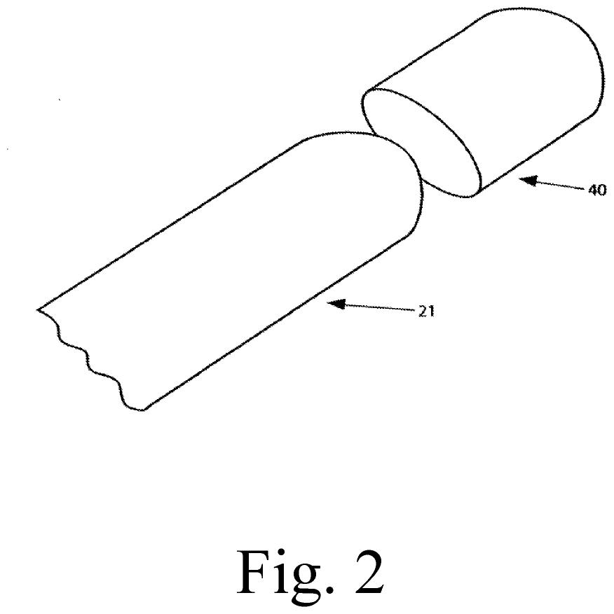

FIG. 2 shows one embodiment of the invention cover 40 and how it is removed or replaced on a compressed air cylinder 21 in linear, form fitting fashion.

One embodiment of the invention solves this issue through the coupling of a mechanism for identifying the air cylinders user. This mechanism is slid over the cylinder end linear to the long axis of the cylinder until it sits flush against the outer cylinder surface. The shape of this embodiment is similar to the shell of the compressed air cylinder, with a diameter only slightly larger than the outer diameter of the air cylinder to ensure a form fit. A flush, form fit is essential to ensure no snag hazards are created for the user who may work in areas that such a hazard could cause entanglement and fatal entrapment. The thickness of the embodiment of the invention would be in keeping with a low profile fit and not so great as to inhibit placement of the bottle within the harness of the SCBA. As a snug fit creates vacuum and pressure between two objects in motion, one embodiment of the invention provides an air exchange hole to allow air exchange in the areas between the air cylinder and the invention when coupling and uncoupling.

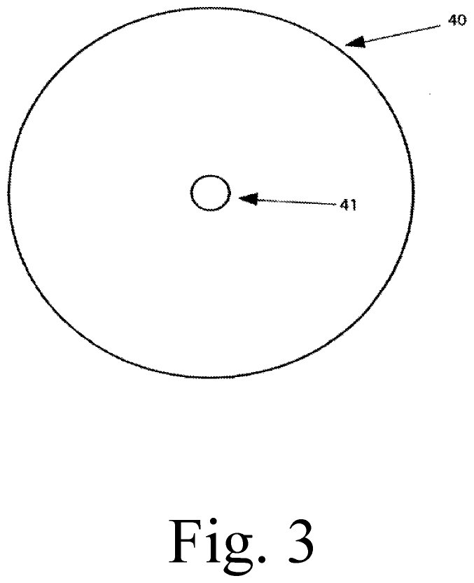

FIG. 3 is an illustration of one embodiment of the invention viewed from the top. It shows the invention 40 and an example of a hole 41 that would allow air to move freely between the invention shell 40 and air cylinder 21 when coupling and uncoupling so as to disperse pressure or limit vacuum in the limited space between the cylinder 21 and invention shell 40 during linear motion.

Visibility is limited in the harsh environment of firefighting. It is extremely difficult for supervisors (i.e. captain, company officer) or fellow firefighters to identify individuals wearing full protective garments and SCBA. The embodiment of the current invention is located on the SCBA compressed air cylinder of the user and is easily seen with visually identifiable information on the outer surface of the invention that includes but is not limited to: (1) color of apparatus; (2) or alpha, numeric or other identifying data on the apparatus.

An example of the benefit of one embodiment can be illustrated when fire personnel are working in a hazardous environment that requires full protective clothing, including donning of the self contained breathing unit. A supervisor (i.e. captain, company officer) responsible for the oversight of a group of personnel can easily see this embodiment of the invention placed on the air cylinder of the SCBA. The unique information found on the embodiment of the invention would inform the supervisor of which unit the worker was assigned and the embodiment of the invention that uses colors could also provide information on their work position (i.e. engineer, paramedic, firefighter).

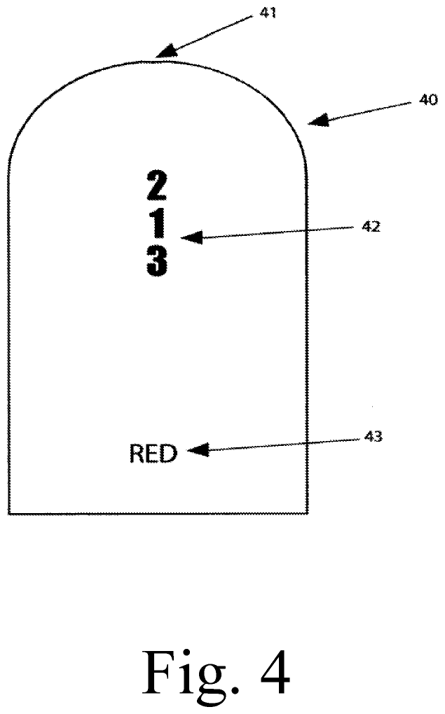

FIG. 4 shows one embodiment of the invention and some examples of how unique identifiers can be used. Numbers 42 are just one example and any variance of marking on the cylinder cover 40 that identifies a user 1 is practical within the embodiment of the current invention. Cover 40 color 43 may also provide identification and serve to parse down the group more precisely. These methods are just some of the examples and the embodiment of the current invention is not limited to these methods.

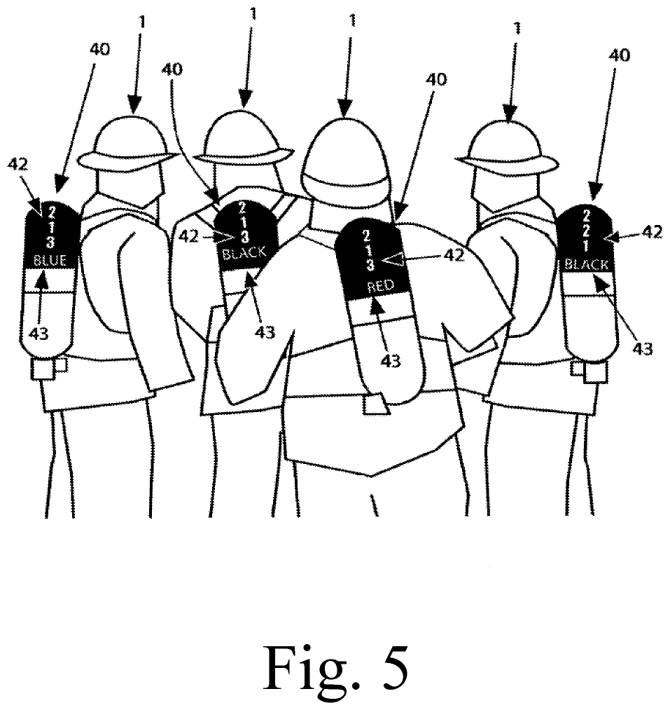

FIG. 5 shows one embodiment of the invention on numerous users 1. Multiple users 1 are identifiable through invention cover 40 which contains identifiers 42 and 43. This view is one frequently encountered by supervising personnel.

Numerous industry documents, including minimum operational standards and post fatality report recommendations, underscore the importance of dependable worker identification and accountability. Examples of how users may be identified and grouped by unit are not limited to the following visible markings on an embodiment of the invention: 213 on red surface (captain), 213 on orange surface (lieutenant or engineer), 213 on black surface (firefighter), 213A on black surface (firefighter), 213 on blue surface (paramedic). This embodiment would allow rapid and accurate identification of all firefighters (the term firefighters is a generic industry term that applies to all personnel including but not limited to engineer, lieutenant, firefighter, paramedic, etc) assigned to the 213 captain.

It is essential that workers within high risk environments are readily identified by peers and accounted for by supervising personnel according to their work units. Crews working in the same group take equipment, such as self contained breathing units (SCBA), from the same location (SCBA stored together on respective fire apparatus). This allows SCBA to be uniquely marked as grouped together (211 red, 211 black, 211 orange) and provides a significant improvement to safety. Highly visual, an embodiment of the invention allows a supervisor to accurately note the location and identification of several workers in proximity. As bottles are often required to be changed during or between work assignments, an embodiment of the invention would allow this information to be easily transferred when exchanging air cylinders, significantly improving worker safety.

Any apparatus attached to an SCBA would be exposed to the harsh conditions found in fire suppression and rescue. As such, it is essential that it be capable of approval by appropriate regulatory bodies that establish standards to prevent firefighter injuries. The NFPA (National

Fire Protection Association) and NIOSH (National Institute for Occupational Safety and Health) are two such agencies that establish standards to keep firefighters safe. NFPA's rugged standards include tests such as continued exposure temperatures of up to 500*F and direct flame contact. The harsh work environments of firefighters requires accessories that are able to meet these regulatory agency safety benchmarks.

The apparatus can be made from a variety of items, including plastic compounds or metals suited for the appropriate environment (i.e. heat and or water) and to ensure the apparatus meets NFPA and NIOSH SCBA accessory standards.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A user identification apparatus for back mounted compressed gas cylinders of self contained breathing units comprising:
a. a means of coupling and uncoupling said identification apparatus,
b. at least one material to cover at least one end of said compressed gas cylinder, or a portion thereof, and
c. at least one unique identifying feature applied to outer face of said identification apparatus to identify the user of said compressed gas cylinder.

2. The user identification apparatus for back mounted compression gas cylinders of self contained breathing apparatus of claim 1, wherein said identification apparatus comprises:
a. a shape matching the compressed air cylinder to which it couples for a form, flush fit to said bottle,
b. an opening to receive compressed gas cylinder linear to long axis of bottle,
c. an opening to receive coupling of the compressed air cylinder similar to, and only slightly larger, the outer diameter of the compressed gas cylinder,
d. an opening small enough to ensure minimal space and a flush fit between inside of apparatus and outside of compressed gas cylinder,
e. an air exchange hole opposite compressed gas cylinder receiving opening, and
f. a rigid body to allow apparatus to be easily slid along body of gas cylinder to couple with said gas cylinder.

3. The user identification apparatus of claim 1 or 2, wherein said at least one material that retains its integrity in high temperatures to prevent damage to said identifying feature.

4. The user identification apparatus of claim 3, wherein the at least one material is selected from aluminum, thermoplastic such as nylon or thermoplastic elastomer, or vulcanized rubber.

5. The user identification apparatus of claim 3, wherein the at least one material is firm to receive an identifiable sticker made for high temperature and/or reflectivity.

6. The user identification apparatus of claim 1 or 2, wherein the user identifying feature is capable of visual recognition by other users.

7. The user identification apparatus of claim 1 or 2, wherein said at least one user identifying feature is a color, alphanumeric, a symbol or a unique marking.

8. The alphanumeric, symbol or unique marking of claim 7, wherein the marking is a sticker.

9. The user identification apparatus of claim 1 or 2, wherein the at least one user identification feature is visual from behind the user.

10. The user identification apparatus of claim 1 or 2, wherein the at least one user identification feature is a semi-permanent marking, such as a sticker, that can be applied by the firefighter or purchasing agency.

11. The user identification apparatus of claim 1 or 2, wherein the at least one user identification feature is a sticker that can be removed.

12. The user identification apparatus of claim 1 or 2, wherein the at least one user identification feature is capable of being changed to reflect updates to user.

13. The user identification apparatus of claim 1 or 2, wherein the method of tracking the user identity can be applied to said apparatus.

14. The user identification apparatus of any of claims 1-13 wherein the identification apparatus is designed to fit a compressed gas cylinder selected from the following: Dräger, MSA, Scott Safety, Honeywell, Interspiro, or Avon self contained breathing apparatus (SCBA) compressed gas cylinder.

15. The user identification apparatus of any of claims 1-14 wherein the identification apparatus is certified by National Institute of Occupational Safety and Health (NIOSH) in accordance with 42 CFR 84.

16. The user identification apparatus of any of claims 1-14 wherein the identification apparatus is designed to meet accessory requirements of the National Fire Protection Association (NFPA) 1981 SCBA standard.

17. The user identification apparatus of any of claims 1-14 wherein the identification apparatus meets the National Fire Protection Association (NFPA) 1981 test for heat and flame resistance as specified in Section 8.11, Heat and Flame Test, and has an afterflame of no more than 2.2 seconds.

18. The user identification apparatus of any of claims 1-14, wherein the user identification apparatus is able to withstand 15 minutes at 203 degrees Fahrenheit and a direct flame test for 10 seconds with an afterflame of no longer than 2.2 seconds.

19. The user identification apparatus of any of claims 1-14, wherein the user identification apparatus meets the NFPA 1981 design requirements.

20. The user identification apparatus of any of the previous claims, wherein said at least one material retains its integrity in high temperatures to prevent damage to said identifying feature.

21. The user identification apparatus of any of the previous claims, wherein the at least one material is selected from aluminum, thermoplastic such as nylon or thermoplastic elastomer, or vulcanized rubber.

22. The user identification apparatus of any of the previous claims, wherein the user identifying feature is capable of visual recognition by other users.

23. The user identification apparatus of any of the previous claims, wherein said at least one user identifying feature is a color, alphanumeric, a symbol or a unique marking,

24. The user identification apparatus of any of the previous claims, wherein the at least one user identification feature is visual from behind the user.

25. The user identification apparatus of any of the previous claims, wherein the identification apparatus is designed to identify the apparatus for matching to user's additional equipment, such as bluetooth connected devices.

26. A method of coupling a user identification apparatus to a compressed gas cylinder comprising coupling a user identification apparatus of any of the previous claims to said compressed gas cylinder.
